(19) United States
(12) Patent Application Publication
(10) Pub. No.: US 2021/0374879 A1
(43) Pub. Date: Dec. 2, 2021

(54) ALPHA SCOUT STAR SYSTEM AND METHOD

(71) Applicant: Alpha Scout, Inc., Plano, TX (US)

(72) Inventors: Raul Varela, Dallas, TX (US); Dustin Collins, Arlington, TX (US)

(21) Appl. No.: 17/331,256

(22) Filed: May 26, 2021

Related U.S. Application Data
(60) Provisional application No. 63/029,841, filed on May 26, 2020.

(51) Int. Cl. G06Q 50/00; G06Q 10/10; G06F 16/22

(52) U.S. Cl. CPC G06Q 50/01; G06F 16/2291; G06Q 10/1053

(57) ABSTRACT

A social media platform for recruiting student-athletes enables student-athletes of any age to create detailed profiles, upload videos and photos, and post information to generate recruiting interest. Coaches, scouts, recruiters, and the like can also create profiles on the platform so they can recruit student-athletes. Artificial intelligence enables coaches and scouts to build prototypical student-athlete profiles and receive notifications when a student-athlete's profile matches a prototypical profile. The coach can then provide a rating for the “match” and provide feedback based on how closely related the prototypical profile and student-athlete profiles are. The Artificial intelligence receives the rating input with feedback and can learn to identify better matches in the future.

### CROSS-REFERENCE TO RELATED APPLICATIONS

This is a Nonprovisional U.S. Patent Application filed under 35 U.S.C. 111(b) claiming priority to Provisional Application Number 63029841, filed May 26, 2020.

### BACKGROUND OF THE INVENTION

### 1. Field of the Invention

The present invention relates generally to the field of NCAA recruiting of student-athletes. More particularly, the present invention relates to a system and method for NCAA coaches and student-athletes to communicate on social media for recruiting.

### 2. Description of Related Art

The National Collegiate Athletic Association (NCAA) has stringent rules limiting communication between NCAA coaches and high school student-athletes. For many sports, NCAA coaches cannot initiate direct messaging and contact with student-athletes until June 15th after the sophomore year in high school. For other sports such as football, baseball, softball and others, NCAA coaches cannot initiate first contact with student-athletes until September 1st of junior year.

Currently, social media platforms are designed for general social interaction between large amounts of people. For example, if a user on Facebook® shares a post publicly, a person can “like” the post and comment on it publicly. Similarly, if a Twitter® user publicly posts (“tweets”) a person can comment or retweet the original post. However, under NCAA recruiting regulations coaches are not allowed to post comments on a Facebook® wall, send private direct messages, or tweet directly at a student-athlete. Coaches can “like,” “favorite”, or “retweet” social media posts in a NCAA rule known as “click, don't type.” This method of indirect communication is limiting and deficient for recruiting purposes because some student-athlete posts can have hundreds or thousands of likes or retweets. One coach's “like” or “retweet” can be obscured by thousands of others. Another issue is that a student-athlete may think one coach/school who retweets and likes all his social media posts is much more interested in him than other coaches. However, the difference in social media interaction could be due to one school having a more extensive and dedicated recruiting staff than others. It may not be a true indication of which coach has the most interest in recruiting the student-athlete. This limited social media interaction is highly inefficient and inhibits the effectiveness of recruiting.

The challenges of recruiting have been exacerbated by a pandemic that will alter the future of recruiting for the foreseeable future. There is a need for a software platform enabling the recruiting process to operate in a virtual and safe environment that is compliant with NCAA rules. The field of social networking lacks a platform dedicated to the NCAA recruitment of student-athletes. There is a demonstrated need for a software platform enabling coaches and student-athletes to effectively communicate on social media within the NCAA's stringent recruiting rules.

### SUMMARY OF THE INVENTION

Systems and methods of a social network platform for recruiting student-athletes are disclosed herein. Student-athletes of any age can create detailed profiles, upload videos and photos, and post information to generate recruiting interest. Coaches, scouts, recruiters, and the like can also create profiles on the platform so they can recruit student-athletes. Coaches can view profiles and media of student-athletes and send (e.g. “click an icon”) Coach Stars to indicate interest. Other members of the public can send Fan Stars to increase exposure for student-athletes. Once a student-athlete receives a Coach Star, he can initiate first direct contact with the coach by sending a message. The coach who receives the first direct contact from the student-athlete can then reply to the message and initiate the recruitment process. The systems and methods are in full compliance with NCAA rules on recruiting of student-athletes. A coach cannot make direct contact until the student-athlete initiates contact first.

A system and method uses artificial intelligence (AI) to enable coaches and scouts to build prototypical student-athlete profiles and receive notifications when a student-athlete's profile matches a prototypical profile. A coach can create a prototypical profile for an ideal athlete with desired attributes and statistics. The prototypical profile can include information such as body measurements, strength, speed, grade point average (GPA), SAT score, sports statistics, and the like. AI software can parse the data collected from coaches and student-athletes. If the coach's prototypical profile is closely related to a student-athlete's profile, the AI can identify a “match”. The AI can transmit the notification to the coach's inbox in the software application, to the coach's phone through short message service (SMS), to an email address, etc. The notification can provide a link to the student-athlete profile. The coach can use the notification link to view the student-athlete profile. The coach can then provide (input) a rating for the “match” and provide feedback based on how closely related the prototypical profile and student-athlete profiles are. The AI receives the rating input with feedback and can learn to identify better matches in the future.

### BRIEF DESCRIPTION OF THE DRAWINGS

FIG. 1 illustrates a flow diagram reciting a system and method of communication on the social media platform.

FIG. 2 illustrates a flow diagram reciting creation of a fan account and actions available to fans on the social media platform.

FIG. 3 illustrates a description of the Coach Star and Fan Star features of the social media platform.

FIG. 4 illustrates an example of a student-athlete profile and actions conducted by a coach logged into the platform.

FIG. 5 illustrates an example of actions conducted by a student-athlete on the platform.

FIG. 6 illustrates an example of interaction and communication between a student-athlete and coach on the platform.

FIG. 7 illustrates an example of a coach logged into the platform viewing a student-athlete profile with an option to send a Coach Star.

FIG. 8 illustrates an example of a student-athlete logged into the platform and viewing a notification of receipt of a Coach Star.

FIG. 9 illustrates an example of a student-athlete making first direct contact with a coach by sending a message.

FIG. 10 illustrates an example of a coach logged into the platform and viewing a message received from a student-athlete.

FIG. 11 illustrates an example of a coach logged into the platform replying to a message from a student-athlete to initiate recruitment.

FIG. 12 illustrates a logic flow diagram of a system and method using artificial intelligence to enable coaches to build prototypical student-athlete profiles and receive notifications when a student-athlete's profile matches a prototypical profile.

### DETAILED DESCRIPTION OF EMBODIMENTS

The following descriptions relate principally to preferred embodiments while a few alternative embodiments may also be referenced on occasion, although it should be understood that many other alternative embodiments would also fall within the scope of the invention. The embodiments disclosed are not to be construed as describing limits to the invention, whereas the broader scope of the invention should instead be considered with reference to the claims, which may be now appended or may later be added or amended in this or related applications. Unless indicated otherwise, it is to be understood that terms used in these descriptions generally have the same meanings as those that would be understood by persons of ordinary skill in the art. It should also be understood that terms used are generally intended to have the ordinary meanings that would be understood within the context of the related art, and they generally should not be restricted to formal or ideal definitions, conceptually encompassing equivalents, unless and only to the extent that a particular context clearly requires otherwise. In light of the present disclosure, those of ordinary skill in the art should also appreciate that many changes can be made relative to the disclosed embodiments while still obtaining a comparable function or result without departing from the spirit and scope of the disclosure.

For purposes of these descriptions, a few wording simplifications should also be understood as universal, except to the extent otherwise clarified in a particular context either in the specification or in particular claims. The use of the term “or” should be understood as referring to alternatives, although it is generally used to mean “and/or” unless explicitly indicated to refer to alternatives only, or unless the alternatives are inherently mutually exclusive. Furthermore, unless explicitly dictated by the language, the term “and” may be interpreted as “or” in some instances. When referencing values, the term “about” may be used to indicate an approximate value, generally one that could be read as being that value plus or minus half of the value. “A” or “an” and the like may mean one or more, unless clearly indicated otherwise. Such “one or more” meanings are most especially intended when references are made in conjunction with open-ended words such as “having,” “comprising” or “including.” Likewise, “another” object may mean at least a second object or more. Thus, in the context of this specification, the term “comprising” is used in an inclusive sense and thus should be understood as meaning “including, but not limited to.” As used herein, the use of “may” or “may be” indicates that a modified term is appropriate, capable, or suitable for an indicated capacity, function, or usage, while considering that in some circumstances the modified term may sometimes not be appropriate, capable, or suitable.

Generally, software are program modules including routines, programs, components, data structures, and other types of structures that perform particular tasks or implement particular abstract data types. A computing device, as used herein, refers to a device comprising at least a memory and a processor. A “computing device” is defined as including desktops, laptops, mobile phones, smartphones, tablets, smart watches, and any other computing device able to support the features described herein. “Plurality” refers to two or more devices or components. Any “examples” described herein are non-limiting. The term “coach” refers to an athletic coach, scout, recruiter, or a similar person affiliated with a NCAA college or university. The term “student-athlete” refers to a student who is also an athlete. The terms “student-athlete”, “athlete”, and “student” can be used interchangeably. The terms “social network platform” and “social media platform” can also be used interchangeably.

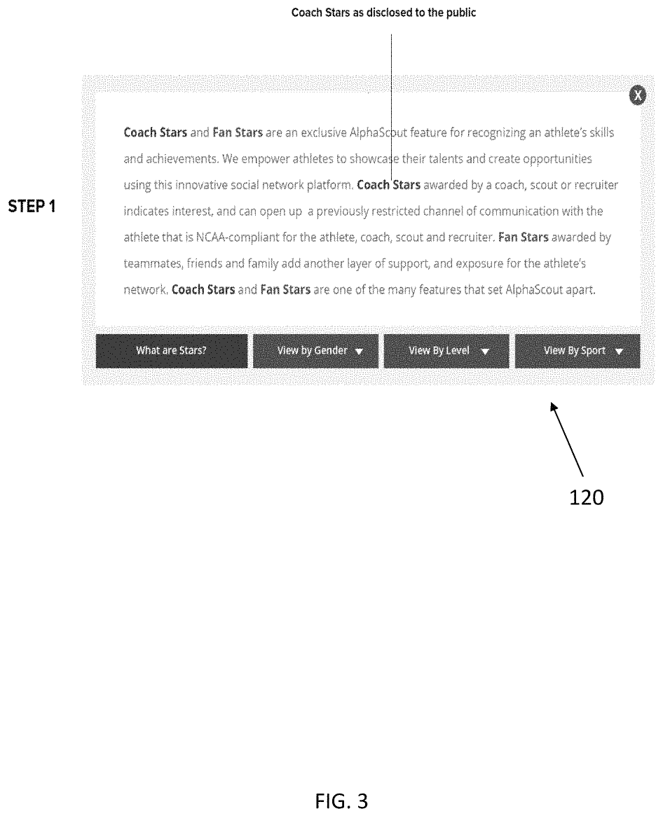

The social media platform described herein is software accessible through a computing device. For example, the social media platform can be accessed online using a desktop, laptop, mobile phone, or tablet. Further, the social media platform can be a software application downloadable and installable on computing devices. The social media platform is implemented on a network of computing devices enabling social networking between many users. A user interface (screenshots shown in FIGS. 3-11) enables users to create profiles, upload media, and send messages, post comments, etc.

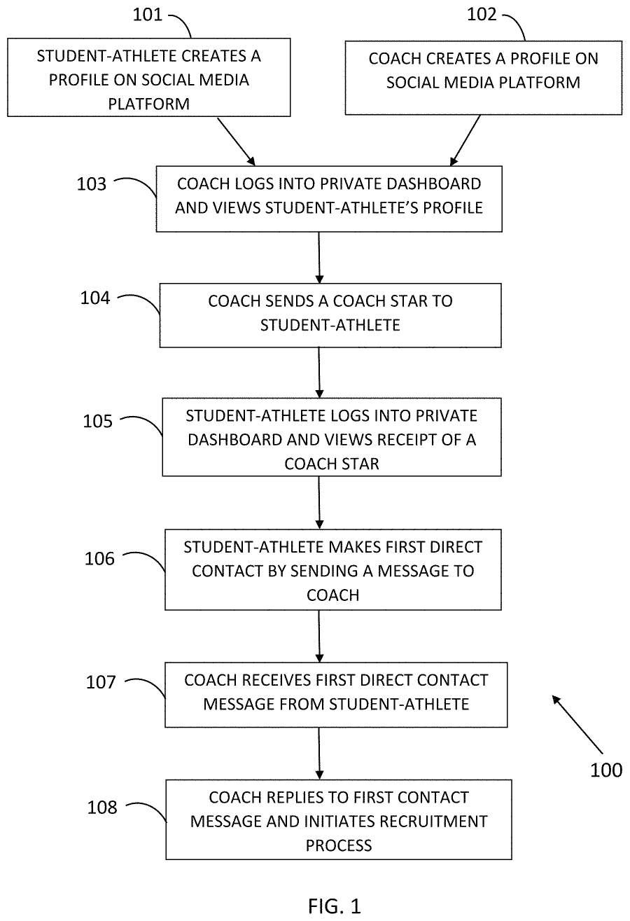

Referring to FIG. 1, there is shown a flow diagram 100 reciting a system and method of communication on the social media platform. Although shown schematically as a series of steps, the steps can be conducted in various orders and embodiments are not limited to the order of steps shown in any of the figures. In step 101, a student-athlete creates a profile on the social media platform. Similarly, a coach creates a profile on the social media platform (102). In step 103, the coach can log into a private dashboard on the platform and view a student-athlete's profile. Coaches can use the social media platform to search for athletes, statistics, and schools. In step 104, the coach can send a “Coach Star” to a student-athlete that he is interested in potentially recruiting. Once a student-athlete logs into a private dashboard, he is able to view receipt of a Coach Star (105). A student-athlete can initiate the first direct contact by sending a message to a coach (106). After a coach receives a first direct contact message from a student-athlete (107), he can reply to the message and initiate the recruitment process (108).

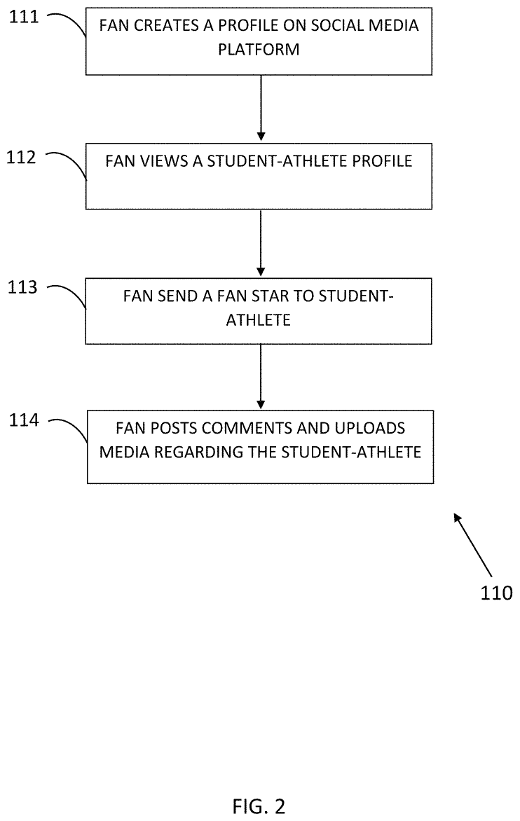

FIG. 2 illustrates a flow diagram reciting creation of a fan account and actions available to fans on the social media platform. Members of the public other than student-athletes and coaches can also create user accounts and profiles. Members of the public include fans, friends, family members, and the like. As used herein, the term “fan” can include any member of the public who is not a student-athlete or coach. A fan can create a fan account and profile (111) in the social media platform. Once a fan creates an account, the fan can view student-athlete profiles (112) and submit content to the platform. Fans can search for student-athletes, statistics, and schools. Fans can create fan pages and groups supporting particular student-athletes. Fans can send Fan Stars to student-athletes (113). The Fan Star is a unique social network feature that enables teammates, friends, family, and others to indicate interest, support a student-athlete, and increase exposure for the student-athlete's social network. Further, fans can post comments regarding a student-athlete and upload media such as videos promoting the athlete (114). Comments can be posted in different places within the social media platform including fan pages and student-athlete profile pages.

Referring to FIG. 3, there is shown a description 120 of the Coach Star and “Fan Star” features of the social network platform. A Coach Star is a unique social network feature that enables a coach to communicate with a student-athlete in compliance with NCAA recruiting rules. A Coach Star can be awarded by a coach, scout, recruiter, and the like to indicate interest in a student-athlete. Coach Stars are disclosed and viewable to any member of the public accessing the social network platform.

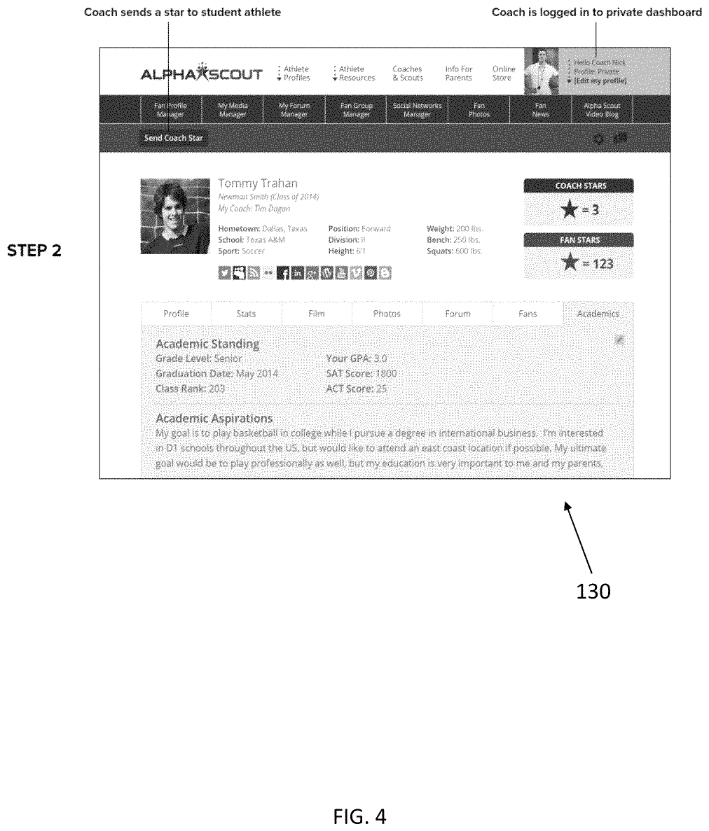

Referring to FIG. 4, there is shown an example 130 of a student-athlete profile and actions conducted by a coach (steps 101, 103, and 104 in FIG. 1) logged into the platform. Within the student-athlete profile 130 created in the social media platform, a student-athlete can add lots of biographical information and media. For example, a student-athlete can create a profile which can include information such as hometown, school, sport, position, division, body measurements, weightlifting strength, and the like. Body measurements can include height, weight In an academics section of the profile, a student-athlete can list their academic standing, scores, and academic aspirations. In another section, a student-athlete can upload individual sports statistics. Further, a student-athlete can add community service records. A student-athlete can also upload videos, photos, and make forum posts. When logged into the platform, a coach, scout, recruiter, and similar can view sections of a student-athlete's profile and send a Coach Star to indicate interest. Other members of the public can send a Fan Star to the student-athlete. Coach Stars and Fan Stars can be transmitted, for example, by clicking on an icon. In the example shown in FIG. 3, the student-athlete “Tommy Trahan” has three Coach Stars and 123 Fan Stars.

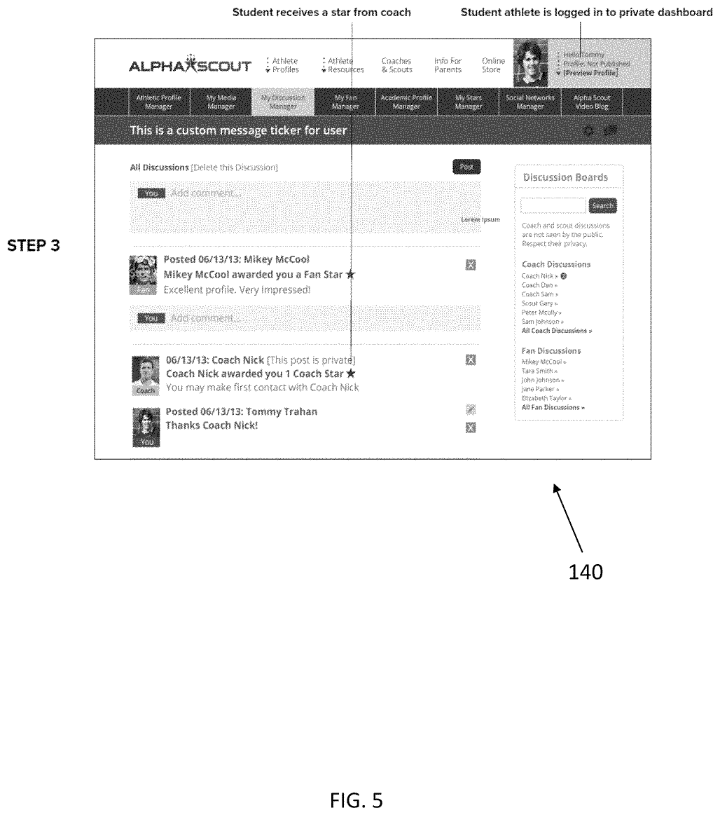

Referring to FIG. 5, there is shown an example 140 of actions conducted by a student-athlete (steps 105 and 106 in FIG. 1) on the platform. When a student-athlete (“Tommy”) is logged in to a private dashboard of the platform, he can view receipt of Coach Stars and Fan Stars. In this example, a message is displayed to Tommy indicating that “Mikey McCool” has awarded a Fan Star and submitted a comment. Another message is displayed indicating that “Coach Nick” has awarded Tommy a Coach Star. In compliance with NCAA recruiting rules, the coach is unable to submit a written comment or message. However, a student-athlete can send a message and make first contact with the coach. In this example, Tommy submitted a comment responding to the Coach Star and thanking Coach Nick.

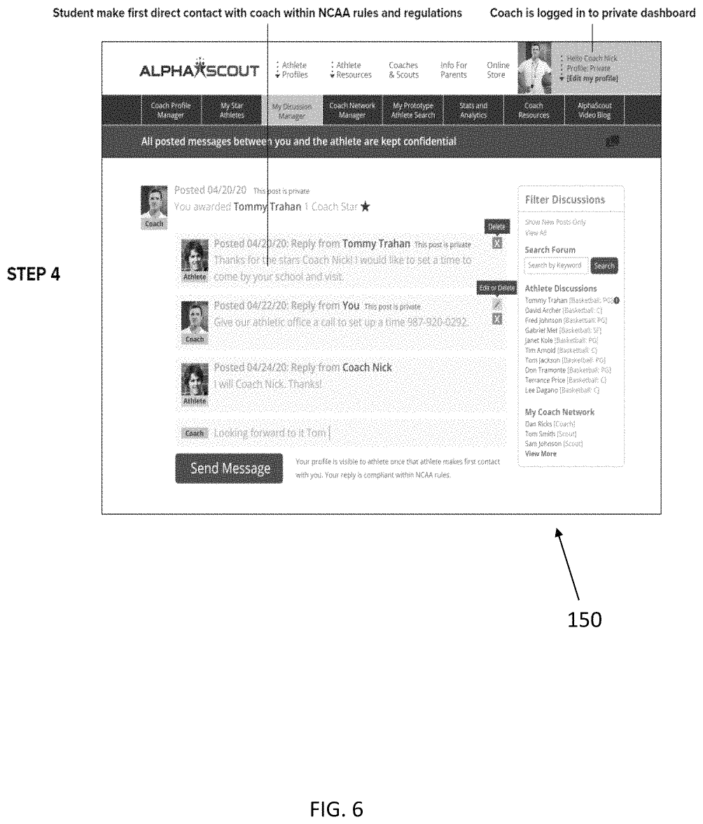

Referring to FIG. 6, there is shown an example 150 of interaction and communication between a student-athlete and coach (steps 107 and 108 in FIG. 1) on the platform. Once a student-athlete makes first contact with a coach by posting a message, the coach can reply with a message in compliance with NCAA recruiting rules. The example shows the sequence of interaction following the initial awarding of a Coach Star to a student-athlete. The messages between coaches and the student-athlete are kept confidential. To view the messages, a coach, scout, recruiter, etc. logs into a private dashboard on the social network platform. Similarly, a student-athlete can view the messages by logging into a private dashboard on the platform.

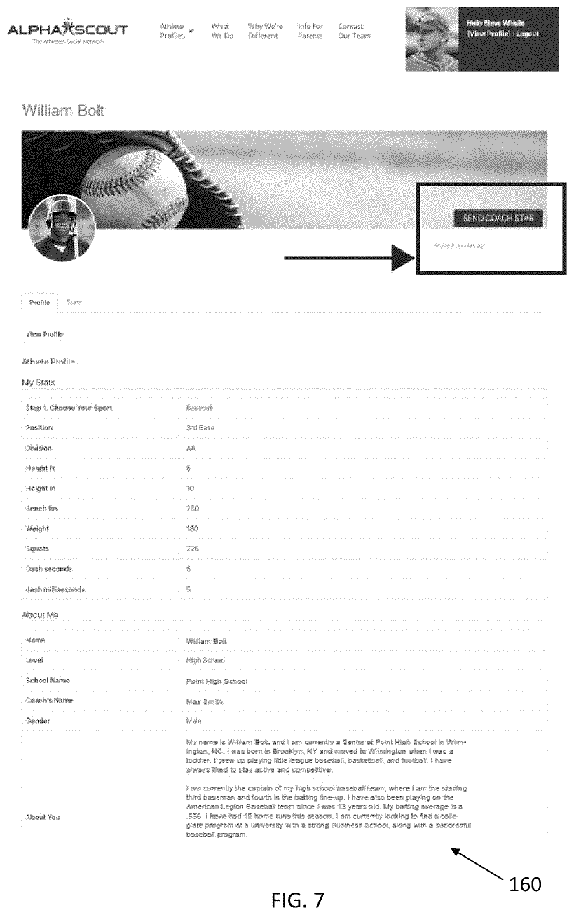

FIG. 7 illustrates an example 160 of a coach logged into the platform viewing a student-athlete profile with an option to send a Coach Star.

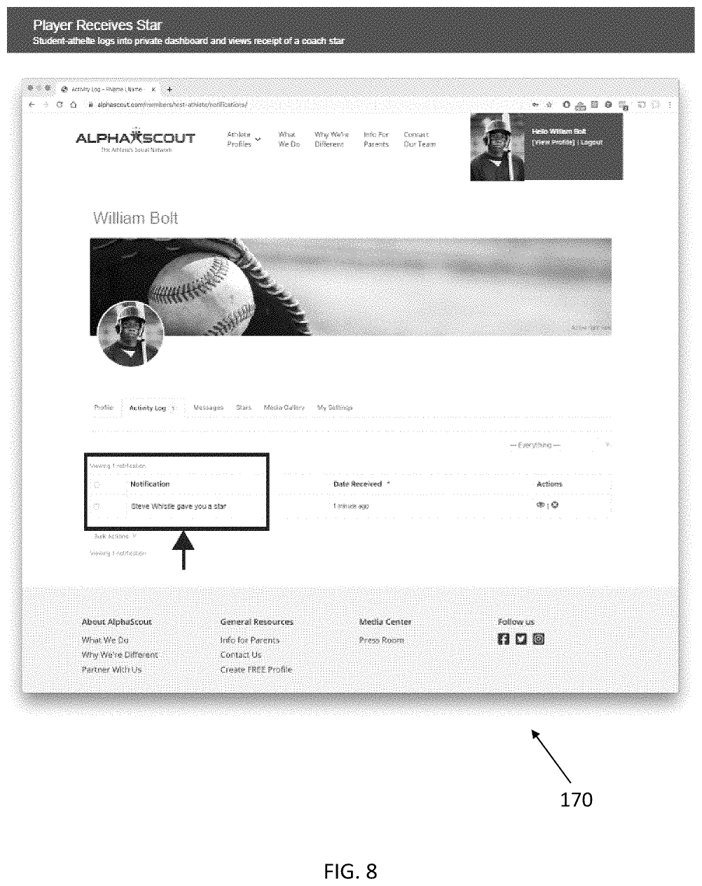

FIG. 8 illustrates an example 170 of a student-athlete logged into the platform and viewing a notification of receipt of a Coach Star.

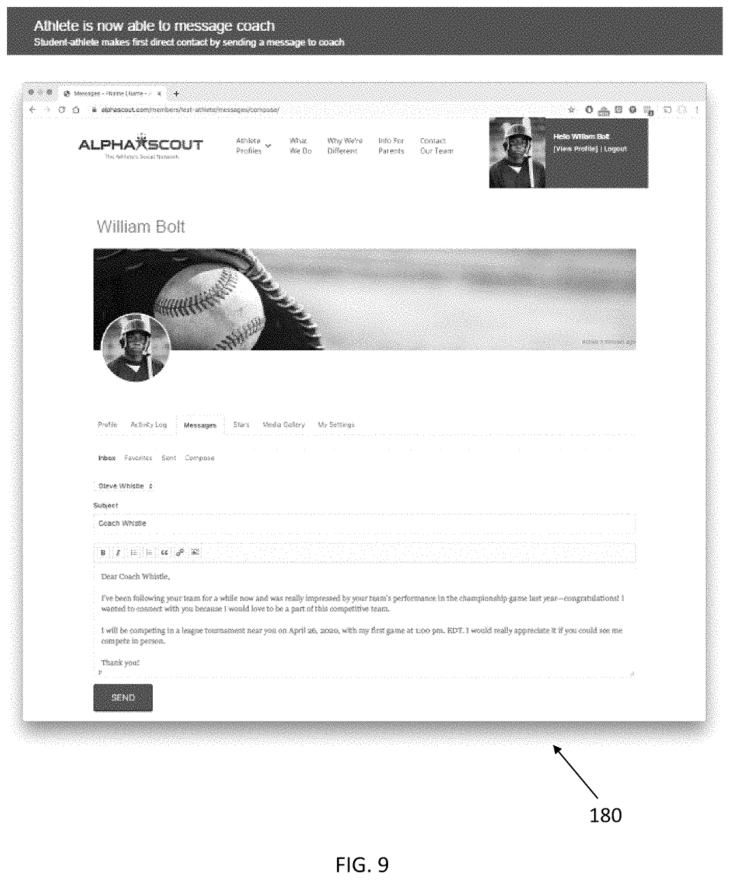

FIG. 9 illustrates an example 180 of a student-athlete making first direct contact with a coach by sending a message.

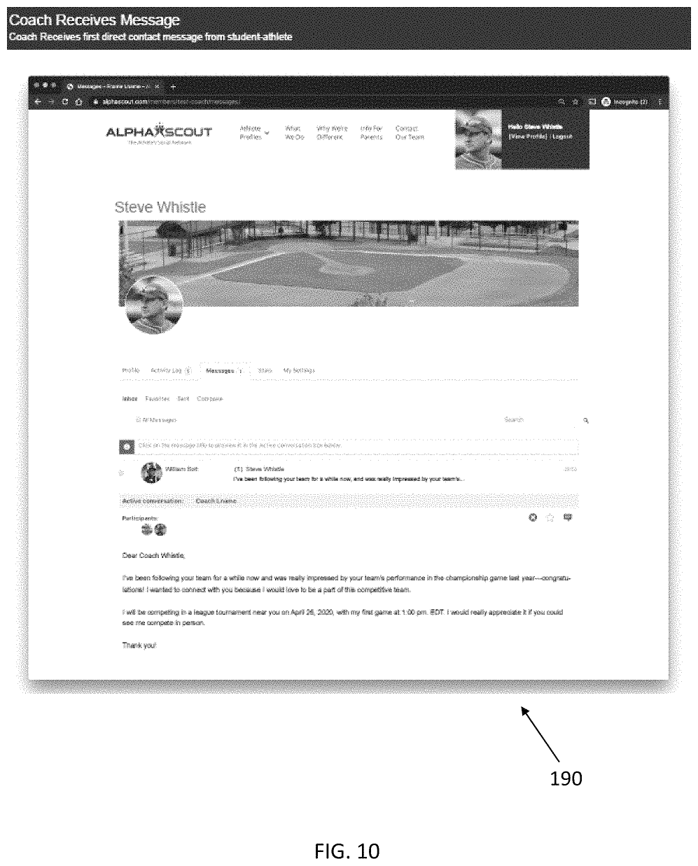

FIG. 10 illustrates an example 190 of a coach logged into the platform and viewing a message received from a student-athlete.

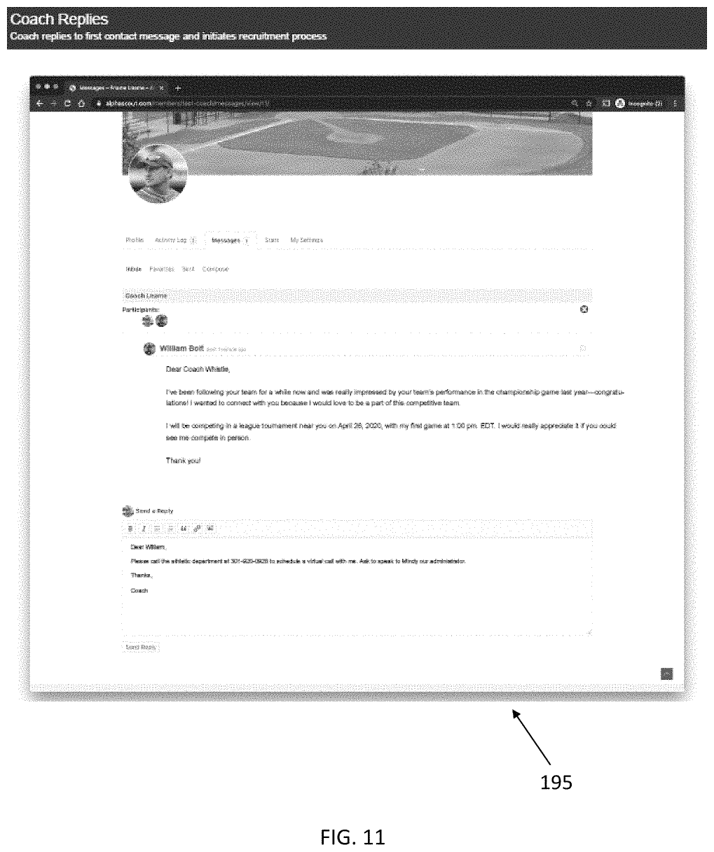

FIG. 11 illustrates an example 195 of a coach logged into the platform replying to a message from a student-athlete to initiate recruitment.

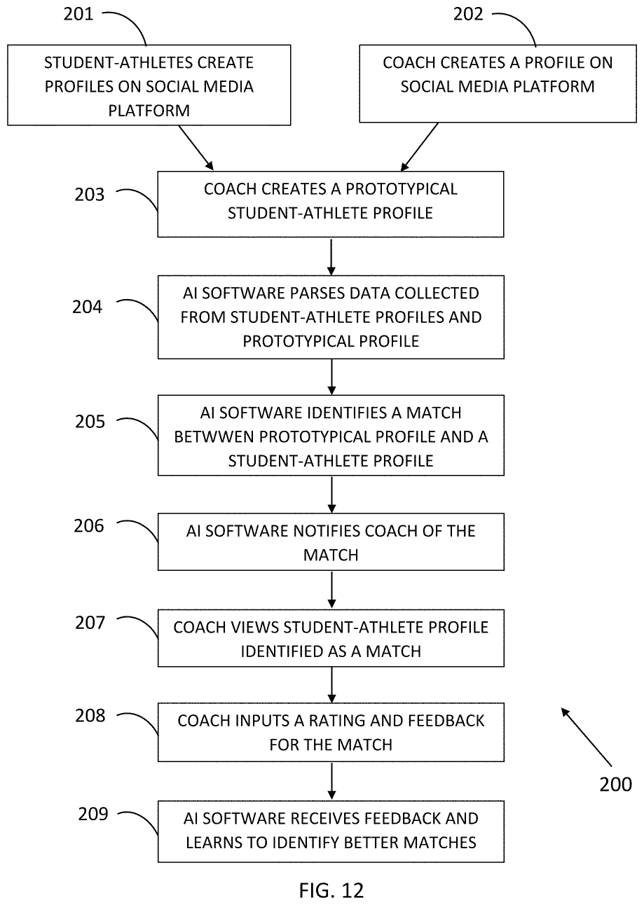

FIG. 12 illustrates a logic flow diagram 200 of a system and method using artificial intelligence (AI) to enable coaches and scouts to build prototypical student-athlete profiles and receive notifications when a student-athlete's profile matches a prototypical profile. In step 201, a plurality of student-athletes can create profiles on the social media platform. Similarly, a coach creates a profile on the social media platform (202). In step 203, a coach can create a prototypical profile for an ideal athlete with desired attributes and statistics. The profile can include information such as height, weight, strength, speed, grade point average (GPA), SAT score, sports statistics, and the like. In step 204, AI software can parse the data collected from coaches and student-athletes. If the coach's prototypical profile is closely related to a student-athlete's profile, the AI can identify a “match” (205) and transmit a notification. In step 206, the AI can transmit the notification to the coach's inbox in the software application, to the coach's phone through short message service (SMS), to an email address, etc. The notification can provide a link to the student-athlete profile. In step 207, the coach can view the notification and use the link to view the student-athlete profile. In step 208, the coach can then provide (input) a rating for the “match” and provide feedback based on how closely related the prototypical profile and student-athlete profiles are. The AI receives the rating input with feedback and can learn to identify better matches in the future (209). The AI software can improve matching accuracy over time as it collects more feedback data. As aforementioned with reference to FIG. 2, fans can also create profiles and interact with student-athletes. Fan interactions can occur in concert with the AI system and method 200 described herein.

1. A method of social networking in a social media platform implemented on a network of computing devices comprising:
a. providing a user interface;
b. registering a student-athlete in the social media platform and creating a student-athlete account;
c. creating a profile for the student-athlete;
d. registering a coach in the social media platform and creating a coach account;
e. creating a profile for the coach;
f. enabling the coach to view the student-athlete profile;
g. enabling the coach to send a coach star to the student-athlete;
h. notifying the student-athlete of receipt of the coach star;
i. providing a link for the student-athlete to view the coach profile;
j. enabling the student-athlete to send a message to the coach;
k. notifying the coach of receipt of the message from the student-athlete; and
l. enabling the coach to reply to the message from the student-athlete.

2. The method of claim 1 further comprising:
a. registering a fan in the social media platform and creating a fan account;
b. creating a profile for the fan;
c. enabling the fan to view the student-athlete profile; and
d. enabling the fan to send a fan star to the student-athlete.

3. The method of claim 2 further comprising: enabling the fan to post comments regarding the student-athlete.

4. The method of claim 3, further comprising: enabling the student-athlete and the fan to upload media.

5. The method of claim 1, wherein the student-athlete profile includes at least one of the following: body measurements, statistics, academic records, and community service records.

6. A social networking system comprising:
a. a plurality of computing devices connected in a network;
b. a social media platform accessible through the plurality of computing devices;
c. a user interface installed in the social media platform;
d. a student-athlete registers in the social media platform and creates a student-athlete account;
e. the student-athlete creates a student-athlete profile in the social media platform;
f. a coach registers in the social media platform and creates a coach account;
g. the coach creates a coach profile in the social media platform;
h. wherein the coach can view the student-athlete profile;
i. wherein the coach can send a coach star to the student-athlete;
j. wherein the student-athlete receives a notification of the coach star;
k. wherein the student-athlete can view the coach profile through a link in the notification;
l. wherein the student-athlete can send a message to the coach in the social media platform;
m. wherein the coach receives a notification of the message from the student-athlete; and
n. wherein the coach can reply to the message from the student-athlete.

7. The system of claim 6 further comprising:
e. a fan registers in the social media platform and creates a fan account;
f. wherein the fan creates a fan profile in the social media platform;
g. wherein the fan can view the student-athlete profile; and
h. wherein the fan can send a fan star to the student-athlete.

8. The system of claim 7, wherein the fan can post comments regarding the student-athlete.

9. The system of claim 8, wherein the student-athlete and the fan can upload media.

10. The system of claim 6, wherein the student-athlete profile includes at least one of the following: body measurements, statistics, academic records, and community service records.

11. A method of social networking in a social media platform implemented on a network of computing devices comprising:
a. providing a user interface;
b. registering a plurality of student-athletes in the social media platform and creating a plurality of student-athlete accounts;
c. creating a plurality of profiles for the plurality of student-athletes;
d. registering a coach in the social media platform and creating a coach account;
e. creating a profile for the coach;
f. enabling the coach to create a prototypical student-athlete profile;
g. parsing data, using artificial intelligence (AI) software, collected from the plurality of student-athlete profiles and the prototypical student-athlete profile;
h. identifying, through the AI software, a match between the prototypical student-athlete profile and a student-athlete profile from the plurality of student-athlete profiles;
i. notifying the coach of the match;
j. providing a link for the coach to view the student-athlete profile identified as the match;
k. enabling the coach to input a rating and feedback for the match;
l. receiving, through the AI software, the rating and feedback for the match; and
m. learning, through the AI software, to identify a better match between the prototypical student-athlete profile and a student-athlete profile from the plurality of student-athlete profiles.

12. The method of claim 11 further comprising:
a. registering a plurality of coaches in the social media platform and creating a plurality of coach accounts; and
b. creating a plurality of profiles for the coaches.

13. The method of claim 11 further comprising:
a. registering a fan in the social media platform and creating a fan account;
b. creating a profile for the fan;
c. enabling the fan to view the student-athlete profile; and
d. enabling the fan to send a fan star to the student-athlete.

14. The method of claim 13 further comprising: enabling the fan to post comments regarding the student-athlete.

15. The method of claim 14, further comprising: enabling the student-athlete and fan to upload media.

16. The method of claim 11, wherein the student-athlete profile includes at least one of the following: body measurements, statistics, academic records, and community service records.

17. A social networking system comprising:
a. a plurality of computing devices connected in a network;
b. a social media platform accessible through the plurality of computing devices;
c. a user interface installed in the social media platform;
d. a plurality of student-athletes register in the social media platform and create a plurality of student-athlete accounts;
e. the plurality of student-athletes create a plurality of student-athlete profiles;
f. a coach registers and creates a coach account in the social media platform;
g. the coach creates a coach profile in the social media platform;
h. the coach creates a prototypical student-athlete profile;
i. wherein artificial intelligence (AI) software parses data collected from the plurality of student-athlete profiles and the prototypical student-athlete profile;
j. wherein the AI software identifies a match between the prototypical student-athlete profile and a student-athlete profile from the plurality of student-athlete profiles;
k. wherein the AI software sends a notification;
l. wherein the coach can view the student-athlete profile identified as the match through a link in the notification;
m. wherein the coach can input a rating and feedback for the match;
n. wherein the AI software receives the rating and feedback for the match; and
o. wherein the AI software can learn to identify a better match between the prototypical student-athlete profile and a student-athlete profile from the plurality of student-athlete profiles.

18. The system of claim 17 further comprising:
a. a fan registers in the social media platform and creates a fan account;
b. wherein the fan creates a fan profile in the social media platform;
c. wherein the fan can view the student-athlete profile; and
d. wherein the fan can send a fan star to the student-athlete.

19. The system of claim 18, wherein the fan can post comments regarding the student-athlete.

20. The system of claim 17, wherein the student-athlete profile includes at least one of the following: body measurements, statistics, academic records, and community service records.
